(19) United States
(12) Patent Application Publication
(10) Pub. No.: US 2003/0019436 A1
(43) Pub. Date: Jan. 30, 2003

(54) Bird feeder assembly and method

(76) Inventor: Timothy E. Nicholas, Traphill, NC (US)

Correspondence Address: Walter L. Beavers, 326 South Eugene Street, Greensboro, NC, 27401, US

(21) Appl. No.: 09/912,722

(22) Filed: Jul. 26, 2001

(51) Int. Cl. A01K 1/00

(52) U.S. Cl. 119/57.92

(57) ABSTRACT

A bird feeder and method is provided having a collar slidably positioned on an upright mounting post. The collar includes sockets for extending arms therefrom to suspend bird feed containers, wind chimes, flower baskets or the like. The collar is connected to a cord and pulley arrangement whereby the feed containers can be raised and lowered as necessary for replenishment, cleaning and maintenance. In the preferred form of the invention a manual winch is attached to the post for ease in raising and lowering the feed containers.

### FIELD OF THE INVENTION

The invention herein pertains to bird feeders and particularly to a hoistable bird feeder having a multiplicity of feed containers.

### DESCRIPTION OF THE PRIOR ART AND OBJECTIVES OF THE INVENTION

In recent years wild bird feeding stations and platforms have become increasingly popular for homeowners and others. Such bird feeders however need to be maintained with regularity to both replenish the feed supply and for cleaning purposes. Most bird feeders which are mounted on a rigid post are difficult to maintain without a ladder unless they are positioned only a few feet from the ground. However, bird feeders which are elevated only a few feet are subject to aggression by dogs, cats, squirrels and other predators whereas bird feeders mounted at a safer height are difficult to maintain and replenish without a ladder or other special equipment. Suspension systems have been developed for raising and lowering bird feeders mounted in trees as shown in U.S. Pat. No. 5,503,108. A bird house such as shown in U.S. Pat. No. 4,702,198 includes a pulley mechanism for raising and lowering the same, while U.S. Pat. No. 3,367,632 demonstrates another mechanism for raising and lowering a bird house mounted on a post.

While the above-identified inventions provide certain bird safety and convenience advantages, there still exists a need for a bird feeder which can be easily raised and lowered for maintenance and which will allow an unobstructed view of the feed containers while the birds are eating or perching.

Thus, with the problems and disadvantages associated with present bird feeders, the present invention was conceived and one of its objectives is to provide a bird feeder which includes a plurality of feeding stations which are all generally visible to remote observers.

It is another objective of the present invention to provide a bird feeder which is free standing for better observation and which does not require a building, tree or the like for support.

It is still another objective of the present invention to provide a bird feeder which allows viewers to see birds perching and roosting while simultaneously viewing others feeding.

It is a further objective of the present invention to provide a bird feeder which can be easily, manually lowered, replenished with feed and raised by an inexperienced individual in a matter of minutes.

It is yet another objective of the present invention to provide a bird feeder which provides safety and security for feeding birds and which helps prevent plunder and vandalism by squirrels and other undesirable animals.

Various other objectives and advantages of the present invention will become apparent to those skilled in the art as a more detailed description is set forth below.

### SUMMARY OF THE INVENTION

The aforesaid objectives and advantages are realized by a bird feeder assembly and method which allows the owner enjoyment while observing and convenience in maintenance. The bird feeder includes a mounting post consisting of an upper section and an anchor section to permit the feed containers thereon to be elevated approximately 3 meters from the ground. In the preferred form of the invention a winch is provided which is manually rotated to wind a cord affixed to a collar to raise and lower the same. The collar includes a plurality of arms from which multiple feed containers are suspended which can be readily observed as birds feed therefrom.

While the main purpose of the device is for use in feeding wild birds, wind chimes, flower baskets or the like can also be supported from the arms as desired. Hoisting and lowering the feed containers, wind chimes or the like is easily accomplished by removing a locking pin in the winch whereby a handle can be rotated to raise or lower the collar as needed. Once the collar has been hoisted to the desired height along the mounting post, the locking pin is replaced which prevents rotation of the handle. The use of the extending arms provide abundant space for many birds to perch simultaneously, while other birds feed. The length of the arms provide separation of the feed containers, permitting various species of birds to be easily viewed at the same time at different food containers without obstruction to the line of sight.

### BRIEF DESCRIPTION OF THE DRAWINGS

FIG. 1 shows the preferred form of the bird feeder of the invention see with the post disassembled for clarity;

FIG. 2 depicts an enlarged view of the top of the post with the collar in a raised posture;

FIG. 3 pictures an enlarged top view of the collar along lines 3-3 of FIG. 1 removed from the mounting post; and

FIG. 4 illustrates an alternate form of the invention with other items suspended from the arms.

### DETAILED DESCRIPTION OF THE PREFERRED EMBODIMENT AND OPERATION OF THE INVENTION

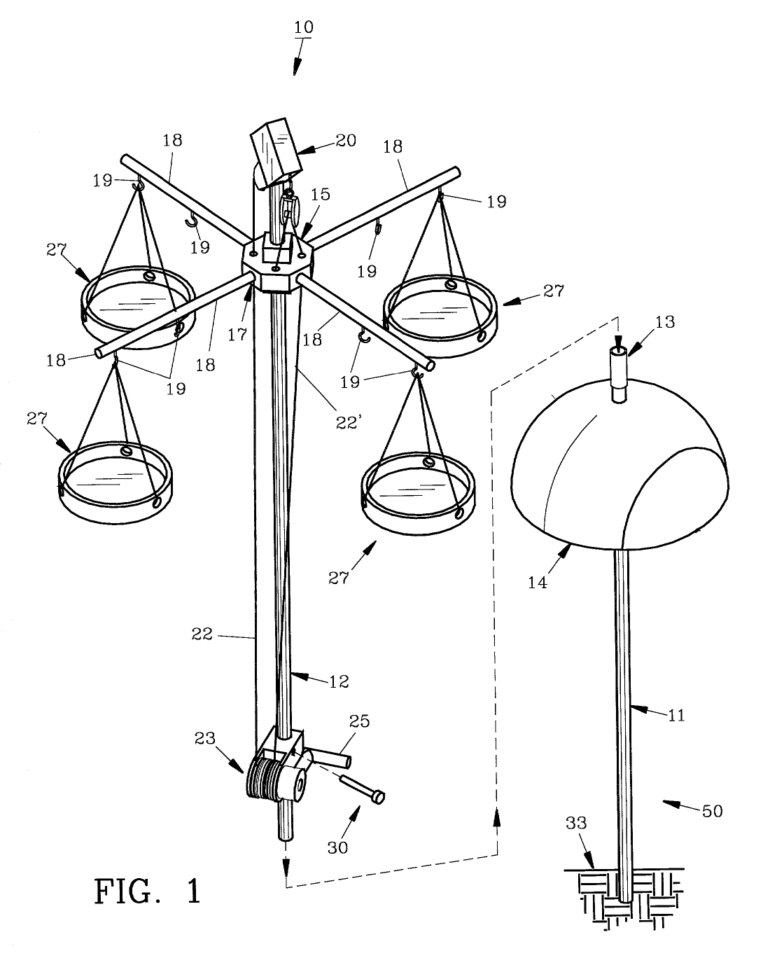

For a better understanding of the invention and its operation, turning now to the drawings, FIG. 1 illustrates preferred bird feeder assembly 10 with tubular mounting post 50 shown disassembled with anchor section 11 separated from upper section 12. Anchor section 11 is preferably formed of aluminum pipe and may have a diameter of approximately ¾″ (1.9 cm) and a length of 1.5 meters for placement in ground 33. Connector 13 is positioned atop anchor section 11 for receiving upper section 12, also preferably formed from aluminum pipe. Connector 13 could also be formed to internally join (not seen) anchor section 11 with upper section 12. A conventional squirrel guard 14 formed from plastic is affixed to anchor section 11 as an added security feature. Collar 15 is slidably positioned along upper section 12 which also has a length of preferably 1.5 m and is preferably formed from wood although it may be formed from aluminum or plastic. While anchor section 11 is seen in ground 33, it could also be so placed and concrete poured therearound for greater durability, or placed at a deeper depth in ground 33 for greater stability.

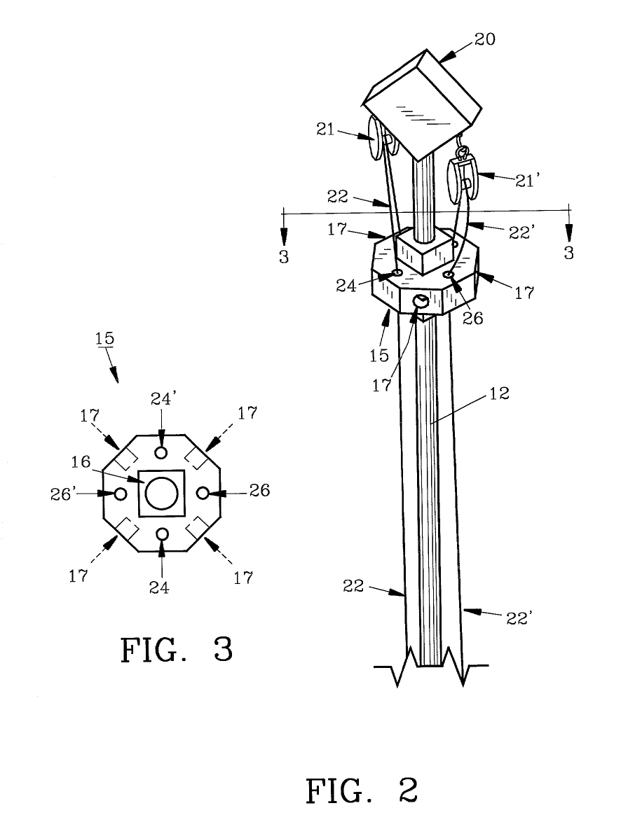

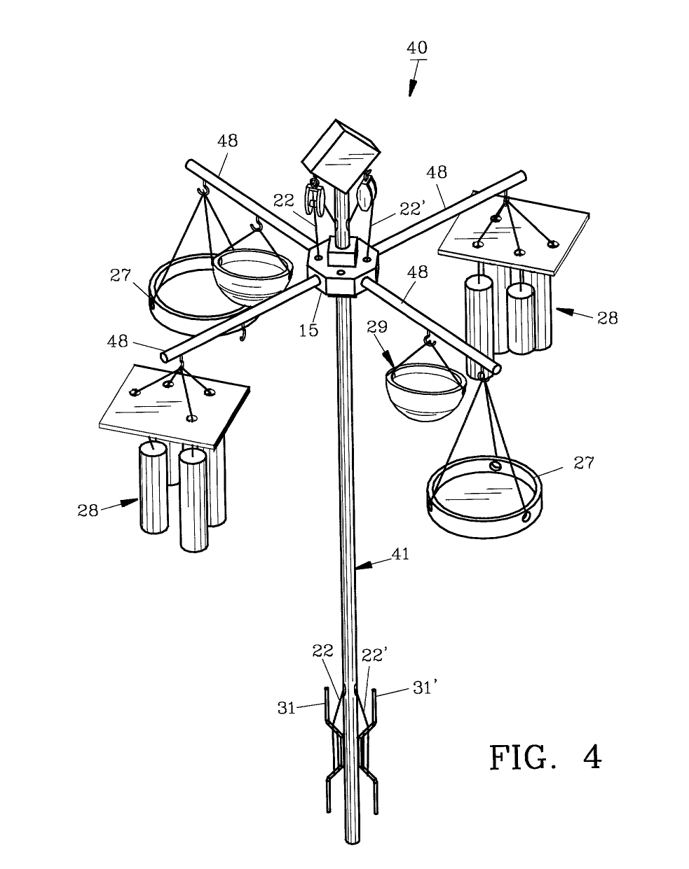

Collar 15 as seen in FIGS. 2 and 3 has a series of preferably four sockets 17 for receiving preferably four arms 18 (FIG. 1). Arms 18 are preferably fastened in sockets 17 by frictional engagement, but could also be glued in place if desired. Arms 18 and collar 15 are both preferably formed of wood. Arms 18 each have a diameter of 1.9 cm for receiving standard threaded metal hooks 19 therealong. Collar channel 16 (FIG. 3) is sized to accommodate upper section 12. While two hooks 19 are preferred on each arm 18, more or less hooks can be utilized as desired. Hooks 19 as described herein are used for suspending feed containers 27 as seen in FIG. 1, or can be used to suspend wind chimes 28, baskets 29 or the like (FIG. 4) as desired by the user. Pulley support 20 is positioned atop upper section 12 as shown in more detail in FIG. 2. Pulley support 20 maintains standard cord pulleys 21, 21′ as shown in FIG. 2 which acts as a pivot members for cords 22, 22′. As would be understood, cords 22, 22′ preferably made of nylon are attached to winch 23 at one end and pass through apertures 24, 26 in collar 15 (FIG. 2), around pulleys 21, 21′ respectively and are then knotted after passing through apertures 24′, 26′ to prevent slippage therefrom as shown in FIG. 3.

As handle 25 of winch 23 is rotated in a clockwise direction as seen in FIG. 1, cords 22, 22′ are wound on winch 23 and collar 15 is hoisted along upper section 12. Pin 30 is inserted into winch 23 at the desired height to prevent rotation (unwinding) of winch 23. To lower collar 15, pin 30 is removed and winch 23 can be manually rotated in a counterclockwise direction whereby collar 15 is then lowered along upper section 12 for cleaning, feed replenishment with usual bird seed or the like.

The preferred method of feeding birds using bird feeder assembly 10 as seen in FIG. 1 includes the steps of driving anchor section 11 into ground 33 a sufficient depth (depending on the soil) for stability. Next, collar 15 with arms 18 attached is joined to upper section 12 by placing upper section 12 into collar channel 16. With cords 22, 22′ passing through collar apertures 24, 26, around pulleys 21, 21′ and through collar apertures 24′, 26′, they are knotted beneath collar 15 for securement. Upper section 12 is then inserted into connector 13 of anchor section 11. Feeder containers 27, wind chimes 28 and the like as desired are then suspended from arms 18. Cords 22, 22′ can then be attached to winch 23 which has previously been mounted on upper section 12. With pin 30 removed handle 25 of winch 23 is rotated in a clockwise direction thus winding cords 22, 22′ thereon to hoist feed containers 27 which have been filled with bird seed (not shown) or other bird food. When the food is depleted feed containers 27 are manually lowered again using winch 23 for quick and easy replenishment.

While preferred bird feeder assembly 10 is operated by winch 23, an alternate embodiment bird feeder assembly 40 is shown in FIG. 4 whereby cords 22, 22′ pass inside upper section 41 and can be manipulated by hand for raising and lowering collar 15 and secured by wrapping cords 22, 22′ around brackets 31, 31′ respectively. Anchor section 11 is not seen in FIG. 4 but would be usually attached during use as in preferred bird feeder assembly 10. Further, as in the preferred embodiment in FIG. 1, arms 48 provide spacing between feed containers 27 or other items to allow an unobstructed observation of a large number of birds feeding and perching simultaneously thereon.

The illustrations and examples provided herein are for explanatory purposes and are not intended to limit the scope of the appended claims.

I claim:

1. A bird feeder assembly comprising: a post, a collar, said collar slidably positioned on said post, an arm, said arm extending from said collar, a cord, a pivot member, said pivot member affixed to said post, said cord attached to said collar and contiguous said pivot member for raising said collar along said post.

2. The bird feeder assembly of claim 1 further comprising a feed container, said feed container attached to said arm.

3. The bird feeder assembly of claim 1 further comprising a cord attachment, said cord attachment mounted on said post.

4. The bird feeder assembly of claim 3 wherein said cord attachment comprises a winch.

5. The bird feeder assembly of claim 4 further comprising a lock pin, said lock pin positionable within said winch, a handle, said handle attached to said winch for rotating the same, said lock pin for preventing rotation of said handle.

6. The bird feeder assembly of claim 1 wherein said pivot member comprises a pulley.

7. The bird feeder assembly of claim 1 further comprising a plurality of arms, each of said arms extending from said collar.

8. The bird feeder assembly of claim 1 wherein said post comprises a tube, said cord contained within said tube.

9. The bird feeder assembly of claim 1 further comprising a hook, said hook attached to said arm for suspending a feed container therefrom.

10. The bird feeder assembly of claim 1 wherein said collar defines a plurality of sockets, each of said sockets for receiving an arm.

11. A bird feeder assembly comprising: a post, a collar, said collar comprising a plurality of sockets, said collar slidably positioned on said post, a plurality of arms, one of said arms positioned in each of said sockets, a cord, a pulley, said pulley attached near the top of said post, said cord passing through said pulley and along said post for raising and lowering said collar, a feed container, said feed container attached to one of said arms whereby said cord can be used to raise and lower said feed container for replenishing food in said feed container.

12. The bird feeder assembly of claim 11 further comprising a winch, said winch mounted on said post and engaging said cord to wind the same.

13. A method of feeding birds with a hoistable feed container comprising the steps of:
a) placing a collar having an arm extending therefrom on an upright post;
b) attaching a feed container to the extending arm;
c) attaching a cord to the collar and extending it through a pulley mounted near the top of said post and downwardly along the post; and
d) manipulating the cord to hoist the feed container along the post.

14. The method of claim 13 further comprising the step of securing the cord to the post.

15. The method of claim 13 further comprising the step of lowering the feed container by manipulating the cord.

16. The method of claim 13 wherein manipulating the cord comprises the step of winding the cord on a winch.

17. The method of claim 13 further comprising the step of placing bird seed in the feed container.
